(19) United States
(12) Patent Application Publication
(10) Pub. No.: US 2009/0212619 A1
(43) Pub. Date: Aug. 27, 2009

(54) SAFETY APPARATUS FOR RETAINING CHILD TO SEAT

(76) Inventors: Nicola S. Crawford, Charlotte, NC (US); Daniel Lee Bizzell, Davidson, NC (US); Carole Ruffin, Cleveland, OH (US)

Correspondence Address: TILLMAN WRIGHT, PLLC, PO BOX 473909, CHARLOTTE, NC, 28247, US

(21) Appl. No.: 12/368,294

(22) Filed: Feb. 9, 2009

Related U.S. Application Data
(60) Provisional application No. 61/027,183, filed on Feb. 8, 2008.

(51) Int. Cl. B60R 22/00

(52) U.S. Cl. 297/483; 297/468

(57) ABSTRACT

A safety apparatus includes a first panel for covering a chest of the person, a second panel for covering a back of the person, and first and second shoulder straps extending between and connecting the first and second panels. The first and second shoulder straps define an area through which the neck of the person extends. First and second guides are attached to opposite side portions of the second panel, and first and second side straps are attached to and extend from opposite side portions of the first panel through the first and second guides, respectively. Ends of the side straps are releasably connected together. A bottom strap is attached to one of the first panel and the second panel and is releasably connected to the other of the first panel and the second panel. The bottom strap and each of the side straps are flexible and are adjustable.

### CROSS REFERENCE TO RELATED APPLICATION

The present application is a U.S. nonprovisional patent application of, and claims priority under 35 U.S.C. §119(e) to, U.S. provisional patent application Ser. No. 61/027,183, filed Feb. 8, 2008, which provisional patent application is incorporated by reference herein.

Furthermore, additional renderings and disclosure of embodiments in accordance with the present invention are included in the Addendum of Appendix attached hereto. This disclosure of additional embodiments is likewise incorporated herein by reference in its entirety.

### BACKGROUND OF THE INVENTION

The present invention generally relates to a safety apparatus for securing a person to a seating apparatus, and more particularly, to a safety apparatus for retaining a child such as a toddler to a seating apparatus.

Parents and care givers are often faced with the issue of providing safe seating options for relatively young children and toddlers. This issue arises during travel, such as short and long trips or vacations, and when performing daily tasks, such as going to the grocery store. This issue often arises when eating out at a restaurant.

For instance, when a care giver is at home with a child, special seating options such as a high chair with specialized straps are available. However, in a restaurant, while a high chair or booster chair may be available, these seating options are generally not of the same level of safety as those available at the child's home. They typically have meager safety straps that are often damaged and unable to be used. In other instances, no special seating for children may be available.

A similar issue arises when using a shopping cart while shopping. A child may be placed in a shopping cart; however, the safety straps provided on a shopping cart are meager at best and often are damaged and inoperable for their intended purpose.

Based on the foregoing, a need exists for a convenient and portable safety apparatus that may used to retain a child to a seating apparatus.

### SUMMARY OF THE INVENTION

The present invention includes many aspects and features.

Accordingly, one aspect of the present invention relates to a safety apparatus for securing a person to a seating apparatus including a first panel for covering a chest of the person; a second panel for covering a back of the person; and first and second shoulder straps extending between and connecting top portions of the first and second panels. The first and second shoulder straps define an area through which the neck of the person extends.

In features of this aspect, first and second guides are attached to opposite side portions of the second panel, and first and second side straps are attached to and extend from opposite side portions of the first panel. The first side strap extends through and is disposed in slidable engagement with the first guide, and the second side strap extends through and is disposed in slidable engagement with the second guide. An end of the first side strap and an end of the second side strap are releasably connected together. A bottom strap is attached to a lower portion of one of the first and second panels and releasably connected to a lower portion of the other of the first and second panels.

A second aspect of the invention relates to a safety apparatus for securing a child to a seating apparatus including a chest panel for covering at least a portion of the chest of the child, a separate back panel for covering at least a portion of the back of the child, and first and second shoulder straps extending between and connecting top portions of the chest and back panels.

In features of this aspect, the first and second shoulder straps define an area between which the neck of the child extends. A bottom strap is attached to a lower portion of one of the chest panel and the back panel and is releasably attached to a lower portion of the other of the chest panel and the back panel. First and second side straps are attached to and extend from opposite side portions of the chest panel. First and second guides are located at opposite side portions of the back panel. In additional features, an overall length of the bottom strap is adjustable for accommodating disposition thereof around an underside of a seating apparatus. Also, the first side strap extends through and is disposed in slidable engagement with the first guide, and the second side strap extends through and is disposed in slidable engagement with the second guide. An end of the first side strap and an end of the second side strap are releasably connected together, and an overall length of the first and second side straps, when connected together, is adjustable for accommodating disposition thereof around a back of the seating apparatus. Moreover, each side strap may be independently adjustable.

A third aspect of the invention relates to a method of securing a person to a seating apparatus, including the steps of arranging a safety apparatus on the person before the person sits in the seating apparatus; extending first and second side straps around a back of the seating apparatus and releasably connecting the ends together for securing the person to the back of the seating apparatus; extending a bottom strap underneath the seating apparatus, from the lower portion of one of first and second panels, to the lower portion of the other of the first and the second panels, and releasably connecting the bottom strap thereto.

In addition to the aforementioned aspects and features of the present invention, it should be noted that the present invention further encompasses the various possible combinations of such aspects and features, including methods of using the safety apparatus disclosed herein.

### BRIEF DESCRIPTION OF THE DRAWINGS

One or more preferred embodiments of the present invention now will be described in detail with reference to the accompanying drawings, wherein the same elements are referred to with the same reference numerals, and wherein,

FIG. 1 is a perspective view of a safety apparatus in accordance with a preferred embodiment of the present invention;

FIG. 2 is a front view of the apparatus of FIG. 1;

FIG. 3 is a front view of a child wearing the apparatus of FIG. 1 while seated in a chair;

FIG. 4 is a rear view of the child wearing the apparatus of FIG. 1 while seated in the chair of FIG. 3;

FIG. 5 is a side view of the child wearing the apparatus of FIG. 1 while seated in the chair of FIG. 3;

FIG. 6 is a front view of a child wearing the apparatus of FIG. 1 while seated in a booster seat;

FIG. 7 is a rear view of the child wearing the apparatus of FIG. 1 while seated in the booster seat of FIG. 6; and

FIG. 8 is a side view of the child wearing the apparatus of FIG. 1 while seated in the booster seat of FIG. 6.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments of the present invention are next described. The following description of one or more preferred embodiments is merely exemplary in nature and is in no way intended to limit the invention, its implementations, or uses.

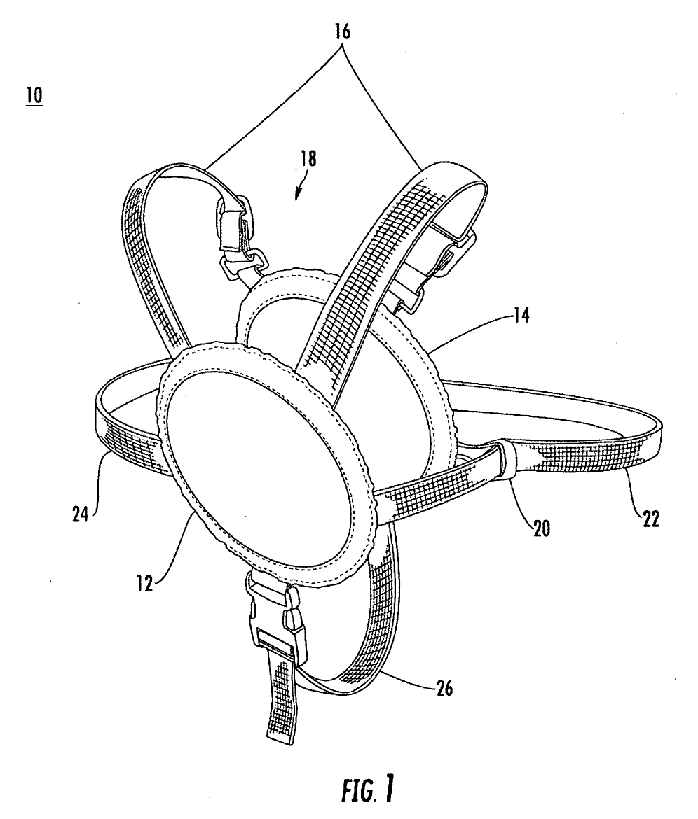

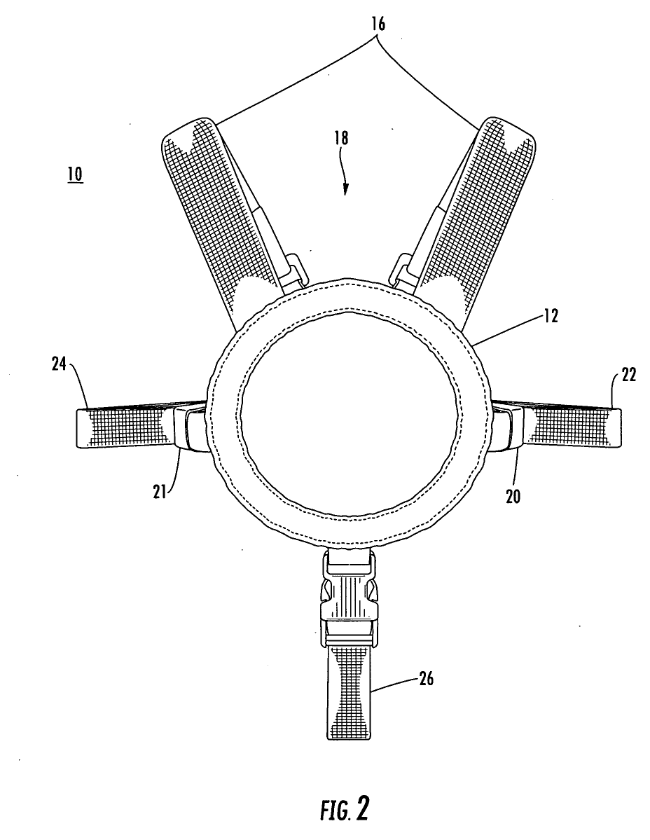

Turning now to FIGS. 1 and 2, a safety apparatus 10 for retaining a child to a seating apparatus in accordance with a preferred embodiment of the present invention is shown. The apparatus 10 includes a first panel 12 for covering at least a portion of a chest of a person, typically a child, and a second panel 14 for covering at least a portion of the child's back. The first and second panels 12,14 are generally circular and may contain a thin layer of padding in order to be more comfortable to a child wearing the apparatus 10. While the embodiment shown herein includes circular first and second panels 12,14, that the first and second panels 12,14 may be any shape that enables at least partial coverage of the chest and back of the person wearing the apparatus 10. It is contemplated that the first and second panels 12,14 will be constructed of a soft but durable fabric such as cotton. It is further contemplated that the first and second panels 12,14 may be made using fabric of colors and/or designs that are appealing to children, e.g., fabrics having bright colors and/or popular cartoon characters.

Shoulder straps 16 extend between and connect top portions of the first panel 12 and second panel 14. The shoulder straps 16 define an area 18 through which the neck of the child extends. Each of the shoulder straps 16 is adjustable in length so that the apparatus 10 can be used as a child grows and also can be used interchangeably between children of different sizes. In the embodiment shown herein, each of the shoulder straps 16 is made from a flexible, durable material, and a portion or all of each shoulder strap 16 may be elastic or inelastic. Also, each shoulder strap 16 preferably is adjustable using a buckle-type length adjuster; however, other types of conventional straps and length adjusters may be used in accordance with the invention, including straps having Velcro fasteners that releasably engage each other.

First and second guides 20,21 are attached to opposite side portions of the second panel 14. Each of the first and second guides 20,21 preferably comprise a strap whose ends are attached to the second panel 14 so as to form a loop. Each of the first and second guides 20,21 may be made from a flexible, durable material. Furthermore, at least a portion or all of each guide 20,21 may be elastic for expansion and contraction of the length of the guides as tension is applied thereto. Alternatively, the guides 20,21 may be inelastic.

First and second side straps 22,24 are attached to and extend from opposite side portions of the first panel 12. The first and second side straps 22,24 each may be made from a flexible, durable material. The first side strap 22 extends and is threaded through the first guide 20 and is configured for sliding therethrough, and the second side strap 24 extends and is threaded through the second guide 21 and is configured for sliding therethrough. The ends of the first and second side straps 22,24 that are not connected to the first panel 12 are releasably connected to one another.

In the embodiment shown, the side straps 22,24 are connected with a buckle and receiver; however, any releasable connection mechanism may be used to releasably connect the ends of the side straps 22,24 together, including straps having Velcro fasteners that releasably engage each other.

For purposes that will become clearer below, first and second side straps 22,24 each has an adjustable length. Furthermore, at least a portion or all of each of the first and second side straps 22,24 may be elastic for expansion and contraction of the length thereof as tension is applied thereto. Alternatively, each of the first and second side straps 22,24 may be inelastic.

A bottom strap 26 attaches to a lower portion of the second panel 14 and releasably connects to a lower portion of the first panel 12. In the embodiment shown herein, the bottom strap 26 is connected to the lower portion of the first panel 12 with a buckle and a receiver; however, any releasable connection mechanism may be used to connect the bottom strap 26 to the first panel 12. The bottom strap 26 may be made from a flexible, durable material.

For purposes that will become clearer below, the bottom strap 26 has an adjustable length. Furthermore, at least a portion or all of the bottom strap 26 may be elastic for expansion and contraction of the length of the bottom strap as tension is applied thereto. Alternatively, the bottom strap 26 may be inelastic.

The apparatus 10 is very compact and portable. It may be easily folded and/or rolled, and stored in a small lightweight carrying case. It is contemplated that the carrying case may be a pouch or small bag constructed from the same fabric as the first and second panels 12,14 of the apparatus 10, thereby forming a matching set.

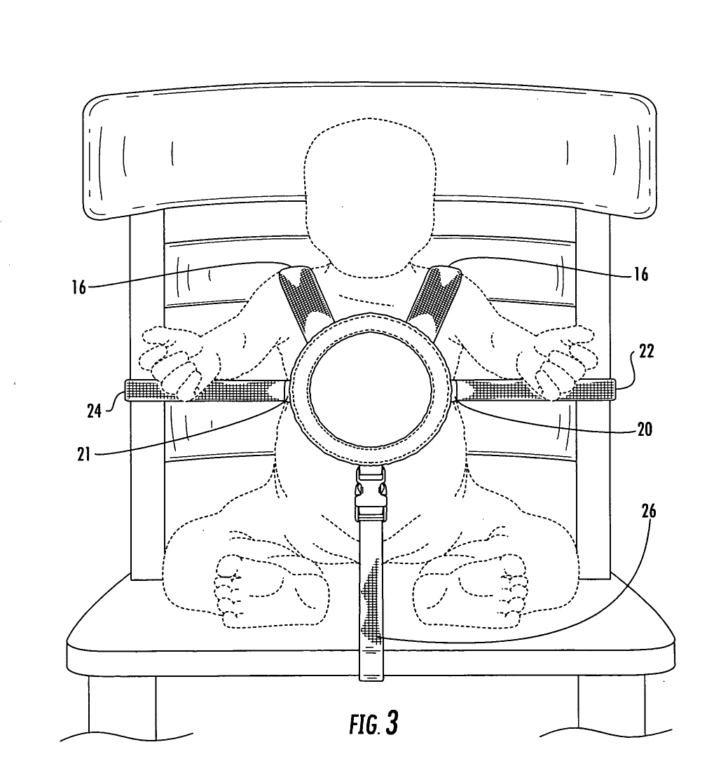

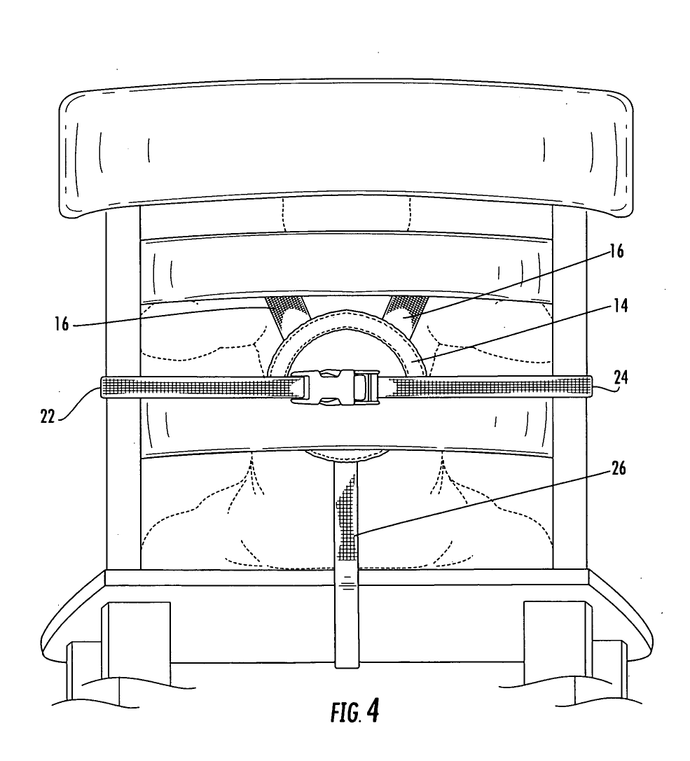

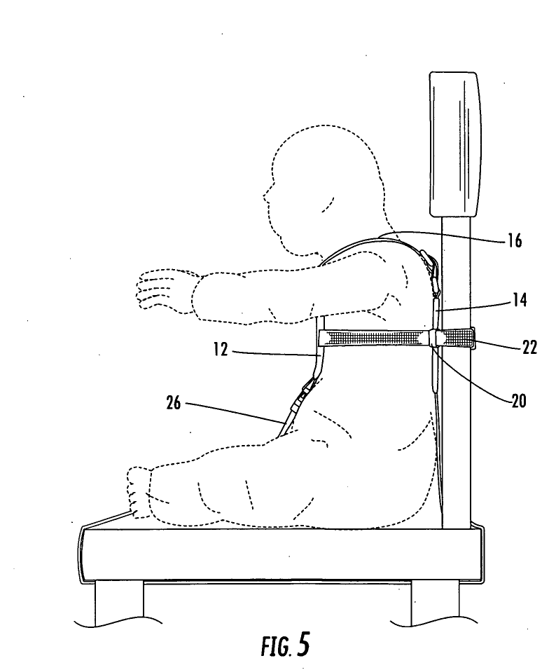

FIGS. 3 through 5 show the apparatus 10 being worn by a child while the child is seated in a chair. When worn, the first panel become a chest panel 12 that is arranged to cover at least a portion of the child's chest and the second panel becomes a back panel 14 that is arranged to cover at least a portion of the child's back. The shoulder straps 16 are supported by the shoulders of the child, and the child's neck extends in the area 18 between the shoulder straps 16. The length of the shoulder straps 16 are independently adjustable and can be adjusted for the comfort and safety of the child.

The side straps 22,24 of the apparatus 10 are threaded through the loops of the first and second guides 20,21 and are releasably connected behind the back of the chair in which the child is seated. The length of the connected side straps 22,24 is adjustable to ensure that the child is tightly held against the back of the chair in which the child is seated.

Although the side straps 22,24 are shown retaining the child to the chair, it will be appreciated that the side straps 22,24 do not have to be used to retain the child to the chair and keep the child from falling. For instance, the child may be sitting on or in a seating apparatus that does not have a back around which the side straps 22,24 may be secured. In such a situation, the length of the connected side straps 22,24 may be shorted such that the side straps 22,24 simply encompass the child, and the bottom strap 26 may be used to secure the child to a bottom of the seating apparatus.

In particular, the bottom strap 26 in FIGS. 3-5, which is sewn to the back panel 14, is routed from back to front under the seat portion of the chair and then connected to the releasable connection mechanism at the lower portion of the chest panel 12. In the illustrated embodiment, the releasable connection mechanism comprises a short strap having one end that is sewn to the chest panel 12 and the other end to which a receiver component is attached for receiving a buckle of the bottom strap 26.

Similar to the side straps 22,24, the length of the bottom strap 26 is adjustable to ensure that the child is held firmly against the seat portion of the chair in which the child is seated. The bottom strap 26 thereby keeps the child from falling.

Additionally, the short strap of the releasable connection mechanism also may have an adjustable length and/or may be elastic.

Although the bottom strap 26 is shown retaining the child to the chair, it will be appreciated that the bottom strap 26 does not have to be used to retain the child to the chair and keep the child from falling. For instance, the child may be sitting on or in a seating apparatus that does not have an underside around which the bottom strap 26 may be routed. In such a situation, the length of the bottom strap 26 may be adjusted such that it is short enough to simply extend between the child's legs from the back panel 14 to the chest panel 12 without undue slack, and the side straps 22,24 may be utilized instead for retaining the child and keeping the child from falling.

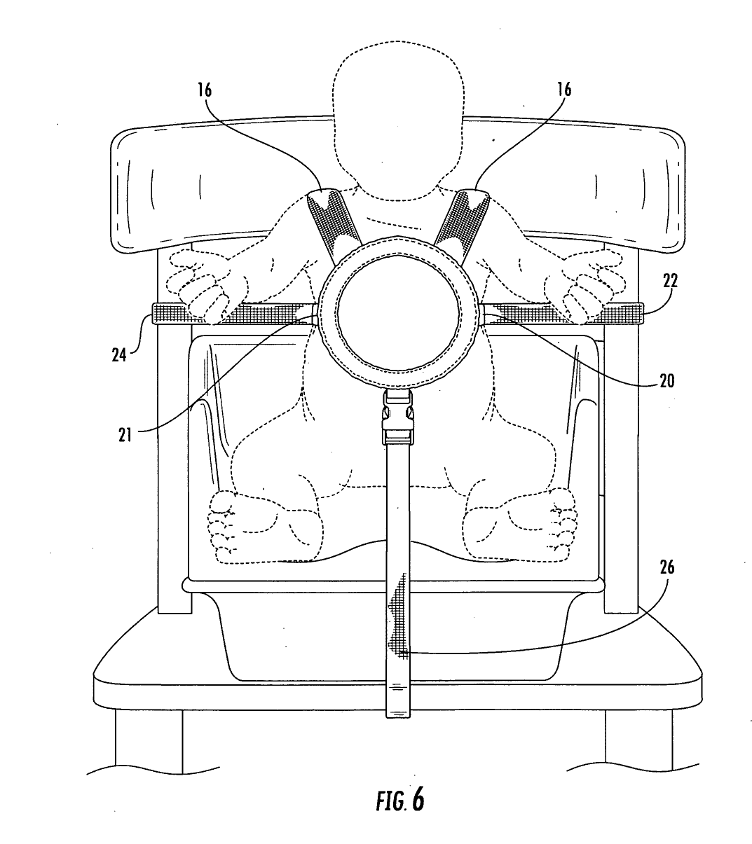

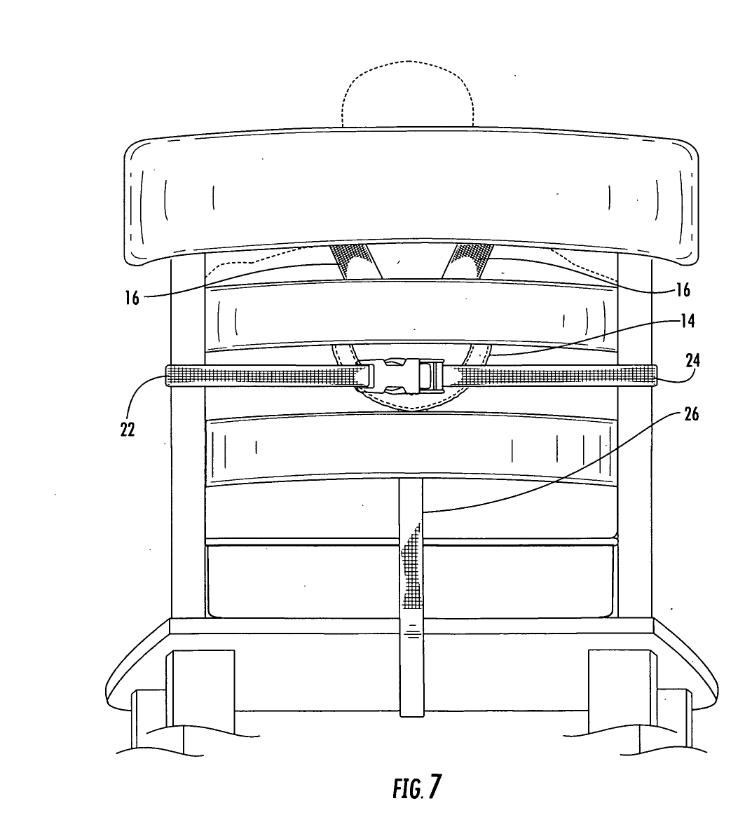

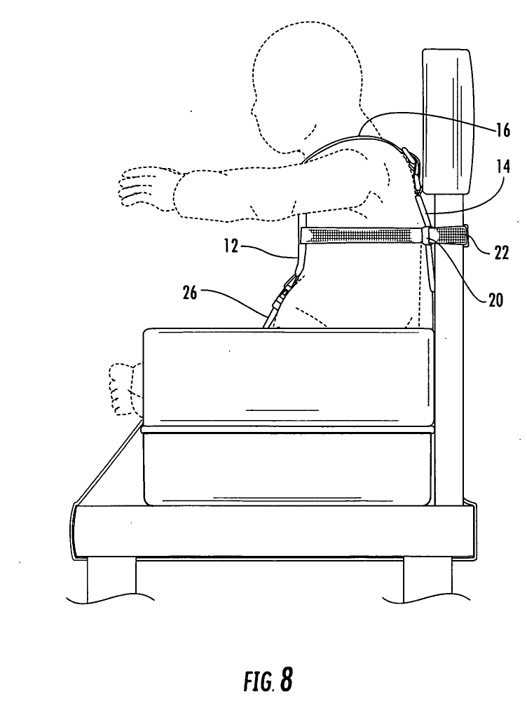

FIGS. 6 through 8 show the apparatus 10 being worn by a child while the child is seated in a booster seat, which has been placed in a chair. Often toddler age children will be seated in booster seats in restaurants and the like. While booster seats are beneficial in helping a child obtain an appropriate height for sitting at a table, they often have little or no safety features associated with them. As shown herein, the apparatus 10 may be used to retain a child to the booster seat and retain the booster seat to the chair in which the booster seat has been placed.

In such a scenario, the child is connected to the back of the chair in the same way as shown and described in FIGS. 3-5 and the accompanying text. In contrast to that shown in FIGS. 3-5, in FIGS. 6-8 the child and the booster seat are connected to the seat of the chair by the bottom strap 26. The length of the bottom strap 26 is adjusted to enable it to be routed under the seat of the chair in which the booster seat has been placed. The bottom strap 26 is releasably connected to the chest panel 12 in the same way as described for FIGS. 3-5. As shown in FIGS. 6-8, the apparatus 10 retains the child to the booster seat and the booster seat to the chair, thereby making the child's seating experience more safe and secure.

Although not illustrated herein, it will be understood that the apparatus 10 may be used to connect a child to a booster seat alone, i.e., to just a booster seat. For instance, it may be desirable to retain a child to a booster seat in the situation where a child is sitting on a booster seat in a booth at a restaurant. In this scenario, the child may be connected to the booster seat using only the bottom strap 26 of the apparatus 10 by extending the bottom strap 26 around the bottom of the booster seat.

Furthermore, while FIGS. 3-8 illustrate a child securely retained in a seated configuration using the safety apparatus 10 with either a chair or a booster seat and chair, it will be readily apparent that the safety apparatus 10 may be used with many different types of seating apparatus including, for example, a high chair, a shopping cart (including grocery cart), etc. The apparatus 10 thus is extremely versatile.

In use, the apparatus 10 may be placed on a child before the child is seated. To don the apparatus 10, a child's neck is disposed in the area 18 between the shoulder straps 16 in order to arrange the chest panel 12 over the child's chest and the back panel 14 over the child's back. In this configuration, the shoulder straps 16 will lie across the top of the child's shoulders.

Once the apparatus 10 is on the child, the child is placed in or on an available seating apparatus. The length of the side straps 22,24 and bottom strap 26 may be adjusted according to the configuration of the available seating apparatus, i.e., the side straps 22,24 and bottom strap 26 may be lengthened or shortened depending on the configuration of the seating apparatus and how the child will be retained on the seating apparatus using the safety apparatus 10. After the length of the side straps 22,24 and bottom strap 26 have been adjusted, as necessary, the side straps 22,24 are connected around the back of the chair and/or the bottom strap 26 is connected around the seat of the chair.

It further should be noted that, in using the safety apparatus 10, the child can actually don (or have put on) the apparatus 10 at home or in a car and can actually be wearing the apparatus 10 when he or she arrives at the location where he or she will be seated, e.g., at a restaurant.

For instance, the child's parents can put the apparatus 10 on the child at home before they leave to go out to eat. Furthermore, the parents can shorten the length of the side straps 22,24 and the bottom strap 26 so that they are not hanging loosely for the ride to the restaurant, and then can lengthen the side straps 22,24 and bottom strap 26 when they get to the restaurant in order to accommodate the configuration of the available seating. Depending on the type of seat available, the parent may want to lengthen the side straps 22,24 and the bottom strap 26; or just the side straps 22,24; or just the bottom strap 26. Alternatively, the parent can take the apparatus 10 to the restaurant (possibly in a matching carrying case) and then put the apparatus 10 on the child after they have arrived at the restaurant.

It is also possible to put the apparatus 10 on the child after he or she has been placed in or on an available seat. Once the child is in or on the seat, a parent may place the apparatus 10 on the child (or the child may place the apparatus on himself or herself). The length of side straps 22,24 and bottom strap 26 can be adjusted, as necessary, and then be connected as desired around the available seating.

The configuration of the safety apparatus 10 enables versatile wearing and use thereof. That is, it may be worn by children of varying sizes and may be used multiple ways with many different types of seating. The design of the apparatus 10 enables it to be light, compact, and portable without sacrificing safety features, and would be appreciated by any parent or care giver who is concerned with child safety.

Additionally, it is contemplated that the safety apparatus 10 may be used for persons other than children. For instance, the safety apparatus 10 may be used for adults or the elderly where an appreciable risk exists of such person falling from a seating apparatus.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

What is claimed is:

1. A safety apparatus for securing a person to a seating apparatus, comprising:
(a) a first panel for covering a chest of the person;
(b) a second panel for covering a back of the person;
(c) first and second shoulder straps extending between and connecting top portions of the first and second panels, the first and second shoulder straps defining an area for receiving there through the neck of the person;
(d) first and second guides attached to opposite side portions of the second panel;
(e) first and second side straps attached to and extending from opposite side portions of the first panel, the first side strap extending through and being disposed in slidable engagement with the first guide, and the second side strap extending through and being disposed in slidable engagement with the second guide, an end of the first side strap and an end of the second side strap being releasably connected together; and
(f) a bottom strap attached to a lower portion of one of the first panel and the second panel and releasably connected to a lower portion of the other of the first panel and the second panel.

2. The safety apparatus of claim 1, wherein the seating apparatus is one of the group of a shopping cart, a high chair, a regular/adult chair, and a booth.

3. A method of securing a person to a seating apparatus, comprising the steps of:
(a) providing the safety apparatus of claim 1;
(b) placing the safety apparatus on the person before the person sits in the seating apparatus;
(c) extending the first and second side straps around a back of the seating apparatus and releasably connecting the ends together for securing the person to the back of the seating apparatus;
(d) extending the bottom strap underneath the seating apparatus, from the lower portion of one of the first panel and the second panel, to the lower portion of the other of the first panel and the second panel, and releasably connecting the bottom strap thereto.

4. The method of claim 3, wherein the seating apparatus is one of the group of a shopping cart, a high chair, a regular/adult chair, and a booth.

5. An apparatus for retaining a child to a seating apparatus, comprising:
(a) a chest panel for covering at least a portion of the chest of the child;
(b) a separate back panel for covering at least a portion of the back of the child;
(c) first and second shoulder straps extending between and connecting top portions of the chest and back panels, the first and second shoulder straps defining an area therebetween for receiving the neck of the child therethrough;
(d) a bottom strap attached to a lower portion of one of the chest panel and the back panel and releasably attached to a lower portion of the other of the chest panel and the back panel;
(e) first and second side straps attached to and extending from opposite side portions of the chest panel; and
(f) first and second guides located at opposite side portions of the back panel;
(g) wherein an overall length of the bottom strap is adjustable for accommodating disposition thereof around an underside of a seating apparatus; and
(h) wherein,
(i) the first side strap extends through and is disposed in slidable engagement with the first guide,
(ii) the second side strap extends through and is disposed in slidable engagement with the second guide,
(iii) an end of the first side strap and an end of the second side strap are releasably connected together, and
(iv) an overall length of the first and second side straps, when connected together, is adjustable for accommodating disposition thereof around a back of the seating apparatus.

6. The method of claim 5, wherein the seating apparatus is one of the group of a shopping cart, a high chair, a regular/adult chair, and a booth.
